(19) United States
(12) Patent Application Publication
(10) Pub. No.: US 2025/0237781 A1
(43) Pub. Date: Jul. 24, 2025

(54) PROCESSES FOR DETERMINING RESERVOIR ROCK QUALITY

(71) Applicants: Schlumberger Technology Corporation, Sugar Land, TX (US); Saudi Arabian Oil Company, Dhahran (SA)

(72) Inventors: Marie Van Steene, Dhahran (SA); Jun Tao Ma, Beijing (CN); Lin Liang, Belmont, MA (US); Wael Abdallah, Sugar Land, TX (US); Mohammed Fadhel Al-Hamad, Dhahran (SA); Shouxiang Mark Ma, Dhahran (SA); Endurance Ighodalo, Dhahran (SA)

(21) Appl. No.: 18/421,228

(22) Filed: Jan. 24, 2024

(51) Int. Cl. G01V 3/32; E21B 49/00

(52) U.S. Cl. CPC G01V 3/32; E21B 49/00; E21B 2200/22

(57) ABSTRACT

Processes for determining dolomitization and reservoir rock quality and processes for using the same are provided. In some embodiments, the process can include determining an average acoustic pore aspect ratio of a formation from an acoustic log of the formation; determining one or more nuclear magnetic resonance (NMR) rock types of the formation from an NMR log of the formation; combining the average acoustic pore aspect ratio and the one or more NMR rock types to determine one or more preferred formation locations; and directing an operational plan for one or more wells using the one or more preferred formation locations.

### FIELD

Embodiments described generally relate to processes for determining reservoir rock quality. More particularly, such embodiments relate to determining dolomitization and reservoir rock quality and directing downhole operations using same.

### BACKGROUND

Obtaining diagenetic information from wireline or logging while drilling (LWD) logs is very challenging. It is usually limited to borehole images where the rock texture can be inferred from visual examination. Diagenetic processes like the dolomitization of calcite are important in understanding reservoir rock quality because dolomite can have a greater pore space than the replaced calcite, but the dolomitization can also degrade rock quality.

Dolomitization can be inferred from traditional mineralogy evaluation using petrophysical logs, such as bulk density, neutron porosity, photoelectric factor, and/or dry weights from neutron spectroscopy. Such petrophysical logs, however, do not provide information about the texture of the rock and provide only limited information about the effect of the diagenetic process on the rock quality, such as a change in porosity and/or permeability. As a result, drilling operations suffer from a lack of information as to how the dolomitization process affected the rock quality in a given formation.

There is a need, therefore, for improved processes for determining the effect of dolomitization on reservoir rock quality and directing downhole operations using same.

### SUMMARY

Processes for determining dolomitization and reservoir rock quality and processes for using the same are provided. In some embodiments, the process can include determining an average acoustic pore aspect ratio of a formation from an acoustic log of the formation; determining one or more nuclear magnetic resonance (NMR) rock types of the formation from an NMR log of the formation; combining the average acoustic pore aspect ratio and the one or more NMR rock types to determine one or more preferred formation locations; and directing an operational plan for one or more wells using the one or more preferred formation locations.

In some embodiments, the process can include locating one or more logging tools in a wellbore traversing a formation to obtain acoustic and NMR logs of the formation; determining an average acoustic pore aspect ratio of the formation from the acoustic log of the formation; determining one or more NMR rock types of the formation from the NMR log of the formation; combining the average acoustic pore aspect ratio and the one or more NMR rock types to determine one or more preferred formation locations; and directing an operational plan for one or more wells using the one or more preferred formation locations.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this disclosure and are therefore not to be considered limiting of its scope, for the disclosure may admit to other equally effective embodiments. It is contemplated that elements disclosed in one embodiment can be utilized in other embodiments without specific recitation.

FIG. 1 depicts a graphical representation of four nuclear magnetic resonance (NMR) rock types, i.e., NMR rock type 1, NMR rock type 2, NMR rock type 3, and NMR rock type 4, according to one or more embodiments described.

FIG. 2 depicts a graph of bound fluid volume (BFV) ratios versus dolomite volume fractions for two lateral wellbores (lateral 1 and lateral 2), according to one or more embodiments described.

FIG. 3 depicts a graph of total porosity minus sonic Wyllie porosity deficits (“sonic Wyllie deficit” or “sonic deficit”) versus dolomite volume fractions for lateral 1 and lateral 2, according to one or more embodiments described.

FIG. 4 depicts a graph of average acoustic pore aspect ratios (“ALPHA REF”) versus dolomite volume fractions for lateral 1 and lateral 2, according to one or more embodiments described.

FIGS. 5A-D depict graphs of sonic Wyllie porosity deficits (“sonic Wyllie deficit” or “sonic deficit”) versus dolomite volume fractions for lateral 1 and lateral 2, separated according to NMR rock type, according to one or more embodiments described. FIG. 5A depicts NMR rock type 1, FIG. 5B depicts NMR rock type 2, FIG. 5C depicts NMR rock type 3, and FIG. 5D depicts NMR rock type 4.

FIGS. 6A-D depict graphs of average acoustic pore aspect ratios (“ALPHA REF”) versus dolomite volume fractions for lateral 1 and lateral 2, separated by NMR rock type, according to one or more embodiments described. FIG. 6A depicts NMR rock type 1, FIG. 6B depicts NMR rock type 2, FIG. 6C depicts NMR rock type 3, and FIG. 6D depicts NMR rock type 4.

FIG. 7 depicts a schematic of an illustrative computing system that can be configured to apply one or more NMR rock types to a comparison of average acoustic pore aspect ratios and dolomite volume fractions, according to one or more embodiments.

### DETAILED DESCRIPTION

It is to be understood that the following disclosure describes several exemplary embodiments for implementing different features, structures, or functions of the invention. Exemplary embodiments of components, arrangements, and configurations are described below to simplify the present disclosure; however, these exemplary embodiments are provided merely as examples and are not intended to limit the scope of the invention. Additionally, the present disclosure can repeat reference numerals and/or letters in the various embodiments and across the figures provided herein. This repetition is for the purpose of simplicity and clarity and does not in itself dictate a relationship between the various embodiments and/or configurations. Moreover, the exemplary embodiments presented below can be combined in any combination of ways, i.e., any element from one exemplary embodiment can be used in any other exemplary embodiment, without departing from the scope of the disclosure.

Additionally, certain terms are used throughout the following description and claims to refer to particular components. As one skilled in the art will appreciate, various entities can refer to the same component by different names, and as such, the naming convention for the elements described herein is not intended to limit the scope of the invention, unless otherwise specifically defined herein. Further, the naming convention used herein is not intended to distinguish between components that differ in name but not function.

Language of degree used herein, such as the terms “approximately,” “about,” “generally,” and “substantially” as used herein represent a value, amount, or characteristic close to the stated value, amount, or characteristic that still performs a desired function or achieves a desired result. For example, the terms “approximately,” “about,” “generally,” and “substantially” may refer to an amount that is within less than 10% of, within less than 5% of, within less than 1% of, within less than 0.1% of, and/or within less than 0.01% of the stated amount. Additionally, unless otherwise indicated herein, all numerical values are “about” or “approximately” the indicated value, meaning the values take into account experimental error, machine tolerances and other variations that would be expected by a person having ordinary skill in the art. It should also be understood that the precise numerical values used in the specification and claims constitute specific embodiments.

Furthermore, in the following discussion and in the claims, the terms “including” and “comprising” are used in an open-ended fashion, and thus should be interpreted to mean “including, but not limited to.”

The term “or” is intended to encompass both exclusive and inclusive cases, i.e., “A or B” is intended to be synonymous with “at least one of A and B,” unless otherwise expressly specified herein.

The indefinite articles “a” and “an” refer to both singular forms (i.e., “one”) and plural referents (i.e., one or more) unless the context clearly dictates otherwise. For example, embodiments using “an optical density difference” includes embodiments where one, two, or more optical density differences are used, unless specified to the contrary or the context clearly indicates that only one optical density difference is used.

The term “rock quality” can include the effect of dolomitization on a rock formation, which can include whether dolomitization changed the rock pore shape and/or whether dolomitization changed the rock pore size and/or whether dolomitization changed the rock porosity. In one or more embodiments, rock quality can include the combination of dolomitization changes of rock pore shape, rock pore size, and rock porosity to determine the effects of dolomite diagenesis of a rock formation.

NMR T₁ and NMR T₂ arrays or distribution logs refer to the longitudinal and transverse relaxation times, respectively. NMR T₁ and/or NMR T₂ arrays or distribution logs can be insufficient at visually identifying recurring features found while drilling long, high-angle wells drilled across a single reservoir. A method called NMR factor analysis (NMRFA) can categorize NMR T₁ and NMR T₂ arrays or distribution logs using a relatively small number of components. These components can be clustered statistically into distinct groups called poro-fluid facies. The poro-fluid facies can include combinations of pore volume, pore size, and fluid NMR properties. The poro-fluid facies can be identified by one or more dominant modes or peaks within the T₁ and/or T₂ distribution measurements. LWD NMR logs can allow NMRFA to be applied while logging, creating one or more real-time T₁ and/or T₂ distribution measurements. Real-time T₁ and/or T₂ distribution measurements can provide a user with stratigraphic understanding of reservoir rock features, such as rock quality and heavy oil deposits. Stratigraphic understanding of reservoir rock features can assist the user with planning well placement, drilling operations, and/or other field operations. In one or more embodiments, real-time T₁ and/or T₂ distribution measurements from multiple laterals can provide real-time updates of reservoir-scale mapping. In one or more embodiments, the poro-fluid facies can be further classified into four NMR rock types.

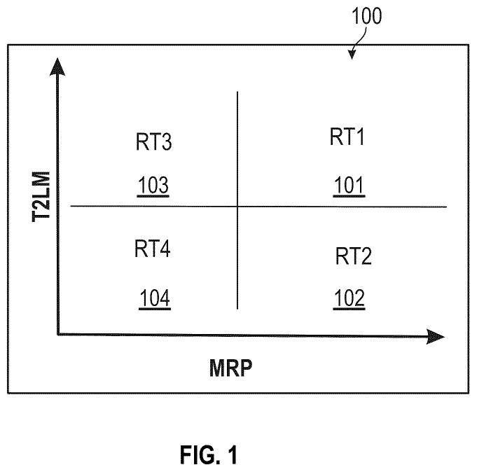

FIG. 1 depicts a graphical representation of four NMR rock types 100, i.e., NMR rock type 1 (RT-1) 101, NMR rock type 2 (RT-2) 102, NMR rock type 3 (RT-3) 103, and NMR rock type 4 (RT-4) 104, according to one or more embodiments. Poro-fluid facies can be grouped based on their mean NMR porosity and NMR T₁ logarithmic mean (T1LM) and/or NMR T₂ logarithmic mean (T2LM) into one of the four NMR rock types, i.e., RT-1, RT-2, RT-3, or RT-4. The T1LM and T2LM can be determined from the logarithmic means of NMR T₁ and NMR T₂, respectively. RT-1 can be classified as high porosity and long T₁ and/or T₂ components, indicating highly porous rock with large pores. RT-2 can be classified as high porosity and medium to short T₁ and/or T₂ components, indicating highly porous rock with small pores. RT-3 can be classified as medium to low porosity and long T₁ and/or T₂ components, indicating minimally porous rock with large pores. RT-4 can be classified as medium to low porosity and medium to short T₁ and/or T₂ components, indicating minimally porous rock with small pores.

In one or more embodiments, the four NMR rock types can be further determined from an NMR porosity cutoff and a T2LM cutoff or a T1LM cutoff. The NMR porosity cutoff and the T2LM cutoff or the T1LM cutoff can be placed according to user and/or evaluation objectives. The NMR porosity cutoff and the T2LM cutoff or the T1LM cutoff can be placed to distinguish rock types based on contrasts between NMR porosity and the T2LM or the T1LM.

A rock formation porosity can be classified as one of relatively high, medium, or relatively low porosity for a given formation. Said another way, high, medium, and low porosity can be a relative measure of porosity for a given rock formation when compared to the surrounding rock formation porosities. In some rock formations, high porosity can refer to a rock formation having a porosity of about 25% or more, whereas, in other rock formations, high porosity can refer to a rock formation having a porosity of about 12% or more. The porosity can be obtained from NMR measurements, where porosity is measured as the initial amplitude of the raw magnetization decay curve, which is directly proportional to the number of polarized hydrogen nuclei in the pore fluid. The initial signal amplitude can be converted to a porosity by taking the ratio of the initial signal amplitude to a tool response in a water tank, which can be referred to as a medium with 100% porosity.

A rock formation can be classified as having long, medium, or short T₁ and/or T₂ components. Long, medium, and short T₁ and/or T₂ components, like the porosity, can be a relative measure of relaxation time distributions of a rock formation when compared to the surrounding rock formation. The T₁ and T₂ components can be obtained from NMR measurements, where the amplitude of the spin-echo-train decay can be fitted by a sum of decaying exponentials, each with a different decay constant. The set of all the decay constants can form the decay spectrum or transverse-relaxation-time (T₂) distribution. The longitudinal relaxation time distribution (T₁) is the set of time constants that characterize an NMR magnetization buildup. In one or more embodiments, T2LM or T1LM values and magnetic resonance porosity (MRP) can be analyzed to determine T2LM or T1LM cutoffs. MRP can provide porosity information and T2LM or T1LM values can provide relative pore size. T2LM or T1LM cutoffs can be determined based upon the MRP, T2LM, and/or T1LM values found at one or more wells. Further information is provided in Hursan et al., Real-Time Facies Characterization Using LWD NMR Factor Analysis in High-Angle Wells. Society of Petroleum Engineers, SPE-713773-MS, 7 Mar. 2023, which is incorporated by reference herein.

Pore structure characterization can be difficult when analyzing rock formations that include wide variations in pore types. Variations in pore types can include, but are not limited to, interparticle pores, intercrystalline pores, moldic pores, vuggy pores, intraframe pores, and/or microcrack pores. Pore structure characterization can be performed with a combination of acoustic and NMR logs. The volume fractions of crack pores (microcracks and microfractures with a low average acoustic pore aspect ratio α), reference pores (interparticle pores with a medium a), and stiff pores (moldic and vuggy pores with an a close to unity) can be calculated through the inversion of an effective medium rock physics model using acoustic logs, such as compressional and shear measurements. In one or more embodiments, the effective medium rock physics model can describe macroscopic properties of composite materials, based on the relative fractions of their components and their properties. At a constituent level, the relative fractions of components and properties are inhomogeneous. The effective medium rock physics model can describe macroscopic acoustic properties of composite materials, based on the acoustic properties of its constituents.

Average acoustic pore aspect ratio α can be determined by inversion of the effective medium model with input of acoustic data. Rock formation can be modeled by incrementally adding pore types to construct an elastic modulus of a dry rock. The rock formation model can be constructed using the following equations (I, II, III, IV, Va, Vb, VIa, and VIb):

$$( 1 - ∅ ) \frac{d}{d ∅} [ {K}^{*} ( ∅ ) ] = ( {K}_{2} - {K}^{*} ) {P}^{\text{(*} 2 )} ( ∅ ) , \qquad ( I )$$

$$( 1 - ∅ ) \frac{d}{d ∅} [ {μ}^{*} ( ∅ ) ] = ( {μ}_{2} - {μ}^{*} ) {Q}^{\text{(*} 2 )} ( ∅ ) , \qquad ( II )$$

$${P}^{*} = \frac{{K}_{m} + \frac{4}{3} {μ}_{i}}{{K}_{i} + \frac{4}{3} {μ}_{i} + {παβ}_{m}} , \qquad ( III )$$

$${Q}^{*} = \frac{1}{5} [ 1 + \frac{8 {μ}_{m}}{4 {μ}_{i} + πα ( {μ}_{m} + 2 {β}_{m} )} + 2 \frac{{K}_{i} + \frac{2}{3} ( {μ}_{i} + {μ}_{m} )}{{K}_{i} + \frac{4}{3} {μ}_{i} + {παβ}_{m}} ] , \qquad ( IV )$$

$$\frac{{K}_{sat}}{{K}_{0} - {K}_{sat}} = \frac{{K}_{dry}}{{K}_{0} - {K}_{dry}} + \frac{{K}_{fl}}{∅ ( {K}_{0} - {K}_{fl} )} , \qquad ( Va )$$

$${μ}_{sat} = {μ}_{dry} , \qquad ( Vb )$$

$${V}_{P} = \sqrt{\frac{K + \frac{4}{3} μ}{ρ}} , and \qquad ( VIa )$$

$${V}_{S} = \sqrt{\frac{μ}{ρ}} , \qquad ( VIb )$$

where subscripts m and i are background matrix and inclusions, respectively, subscripts dry and sat are dry and saturated rock, respectively, subscript fl is fluid, superscript * and subscript 0 are initial conditions, K is effective bulk moduli, u is the effective shear moduli, and P^{(*2)} and Q^{(*2)} are geometrical factors dependent on a of elliptical pores. Further information is provided in Juntao et al., Pore System Characterization of Carbonate Rocks: a Multiphysics Approach through Acoustic and NMR Measurements. SPWLA 64th Annual Loggin Symposium, SPWLA-90230-0051, 10-14 Jun. 2023, which is incorporated by reference herein.

The rock formation quality can be determined based upon changes in rock pore shapes, e.g., through the average pore aspect ratio, and/or rock pore size and/or rock porosity. The average acoustic pore aspect ratio can be used to indicate the effect of dolomitization on the rock and/or whether the dolomitization changed the rock pore shape and/or rock pore size and/or rock porosity. The T2LM or T1LM values can indicate whether the dolomitization changed the rock pore size. The combination of the average acoustic pore aspect ratio, the T2LM or T1LM, and porosity values can indicate effects of dolomite diagenesis on rock quality.

LWD logs for a given well can be obtained that can provide well depth, total porosity (PHIT), acoustic logs, average aspect ratio, sonic Wyllie porosity (SWP) versus PHIT, and NMR logs. PHIT can be determined by the equation (VII),

$${Φ}_{t} = \frac{{R}_{ma} - {R}_{B}}{{R}_{ma} - ( {R}_{mf} \cdot {S}_{xo} + {R}_{HC} \cdot ( 1 - {S}_{xo} ) )} , \qquad ( VII )$$

where Rₘₐ is grain density, R_{B} is density log measurement, R_{mf} is mud filtrate density, R_{HC} is hydrocarbon density and Sₓₒ is water saturation. The PHIT can include PHIT values associated with different rock types, including but not limited to, anhydrite, calcite, dolomite, and the like. The acoustic logs can include compressional slowness (DTCO), shear slowness (DTSH), and/or any other relevant acoustic log of reservoir rock. The SWP vs PHIT data can include comparisons between SWP, PHIT, bound fluid volume (BFV), and MRP. The NMR logs can include T₁ distributions, T₁ cutoffs, T1LM, T₂ distributions, T₂ cutoffs, and/or T2LM. The values from the LWD log can be correlated to a depth in the well the logs were acquired in.

The SWP can be computed from a standard formation evaluation process, using the equation (VIII),

$$\frac{1}{v} = \frac{{Φ}_{t}}{{v}_{f}} + \frac{1 - {Φ}_{t}}{{v}_{m}} , \qquad ( VIII )$$

where v is compressional velocity (the inverse of DTCO), v_{f} is fluid velocity, vₘ is rock matrix velocity, and Pt is the SWP. The difference between PHIT and SWP, or SWP deficit, can be used as an indication that the average acoustic pore aspect ratio deviates from a common value of 0.15. The higher the pore aspect ratio, the greater the difference between SWP and PHIT.

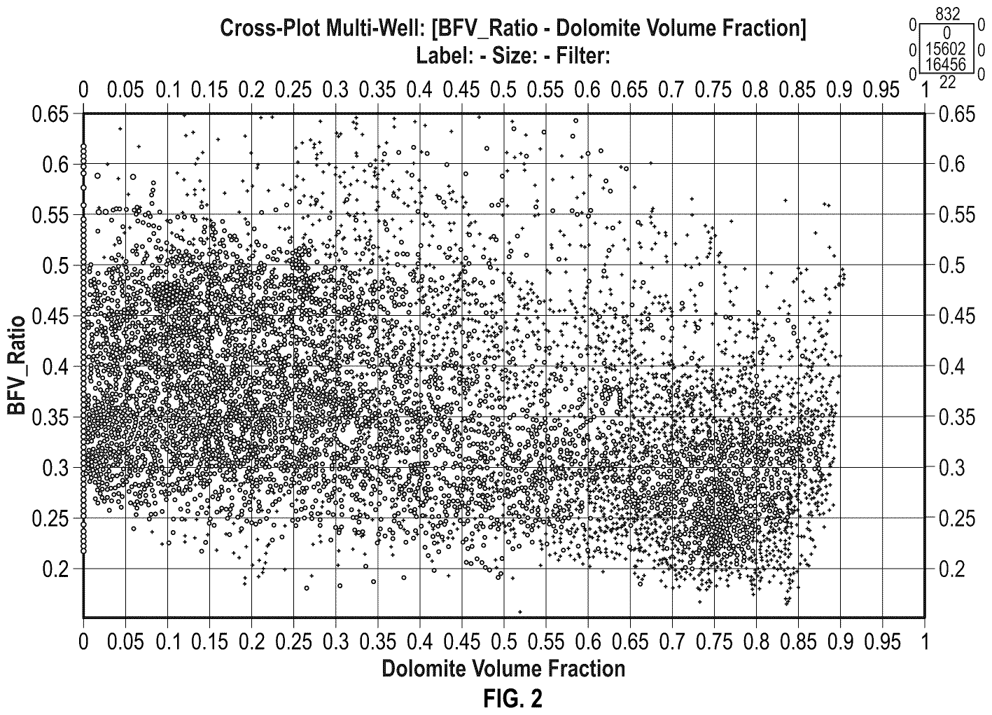

LWD logs for two laterals (lateral 1 and lateral 2) in a well were obtained that provided well depth, PHIT, an acoustic log, average acoustic pore aspect ratio, SWP versus PHIT data, and an NMR log. In FIGS. 2-6, the circles indicate the results for lateral 1 and the crosses indicate the results for lateral 2. FIG. 2 depicts a graph of BFV ratios versus dolomite volume fractions, according to one or more embodiments. The BFV ratio can be determined using NMR BFV and dividing by the NMR total porosity. The BFV ratio indicates the relative amount of fluid locked within the pores of a reservoir rock, with lower values of BFV indicating larger and/or more numerous pores that allow fluid to move more freely. The dolomite volume fraction can be determined using any suitable method for determining mineral concentration, such as mineral solver methods. Mineral solver methods can include inversion of a matrix system, where a tool's response is equal to a tool's response endpoints for a given formation fluid multiplied by the formation matrix and fluid volumes. The dolomite volume obtained from the mineral solver can be driven by the values of neutron porosity and/or bulk density, and also the photoelectric factor measurements if barite is absent from mud filtrate. Mud filtrate can include any drilling fluid, drilling mud, and/or other material forced into the rock formation from the wellbore due to pressure gradients while producing. As indicated in the FIG. 2, higher dolomite volume fractions can correlate to lower BFV ratios, which can indicate the dolomite has larger pores than surrounding anhydrite, calcite, and other rock compositions. Graphical points can be derived from the LWD logs of one or more laterals. Further information about the mineral solver process is provided in Quirein et al., A Coherent Framework for Developing and Applying Multiple Formation Evaluation Models. SPWLA 27th Annual Logging Symposium, 9-13 Jun. 1986, which is incorporated by reference herein.

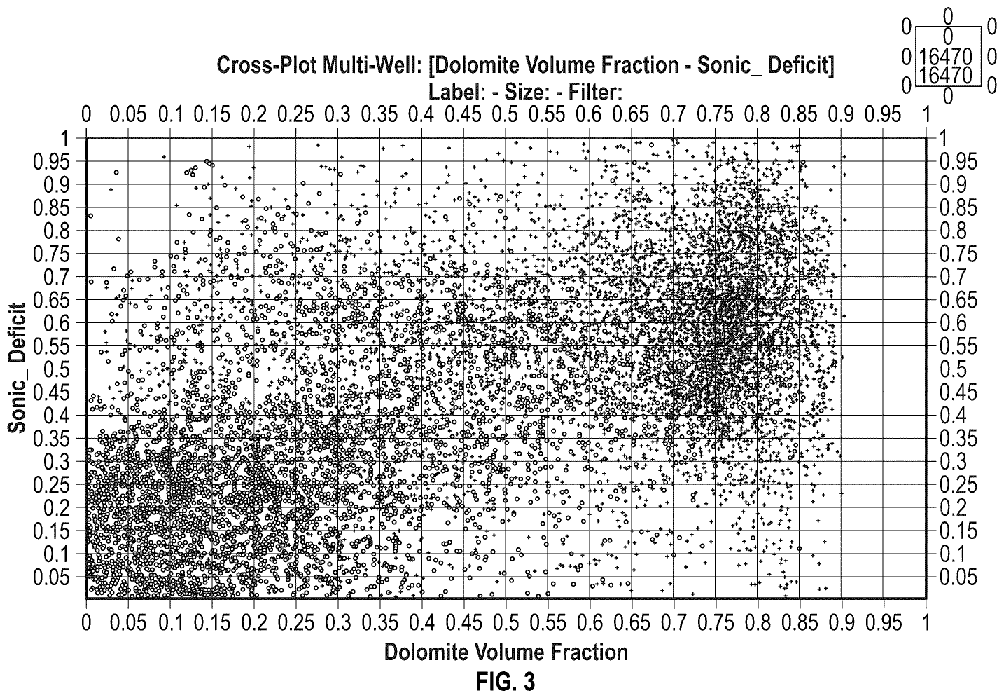

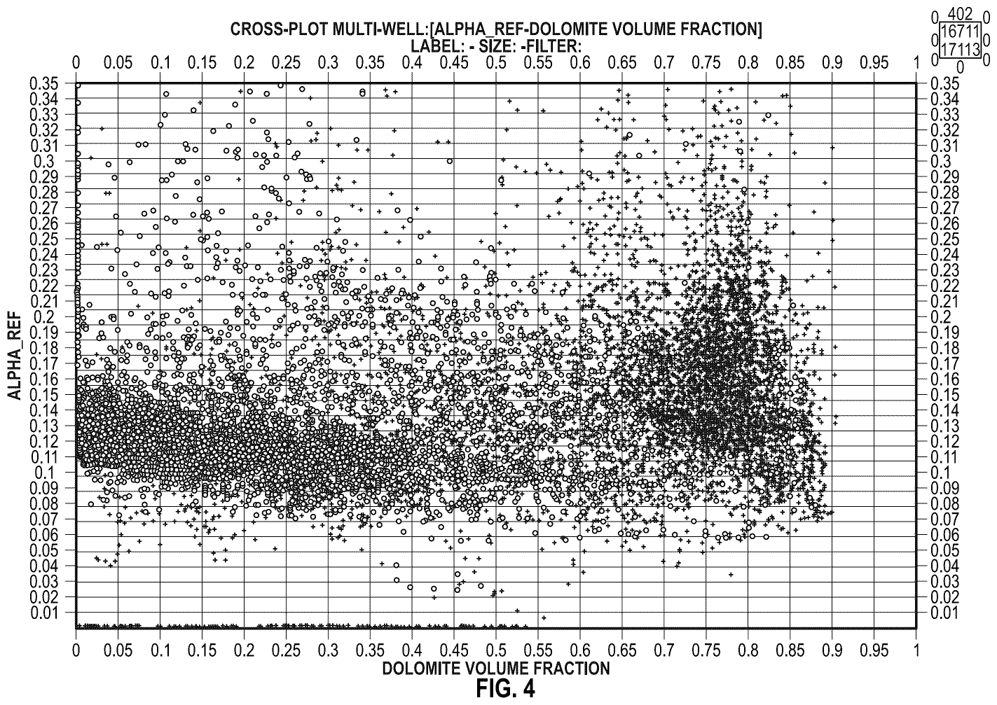

FIG. 3 depicts a graph of SWP deficits (“sonic deficit”) versus dolomite volume fractions, according to one or more embodiments. As indicated by FIG. 3, higher dolomite volume can correlate to higher SWP deficits, indicating dolomite can have more spherical pores than surrounding anhydrite, calcite, and the like. Graphical points can be derived from the LWD logs of one or more laterals.

FIG. 4 depicts a graph of average acoustic pore aspect ratio (“ALPHA REF”) vs dolomite volume fractions, according to one or more embodiments. As indicated by FIG. 4, higher dolomite volume can correlate to greater average acoustic pore aspect ratios, indicating dolomite can have more spherical pores than surrounding anhydrite, calcite, and the like. Graphical points can be derived from the LWD logs of one or more laterals.

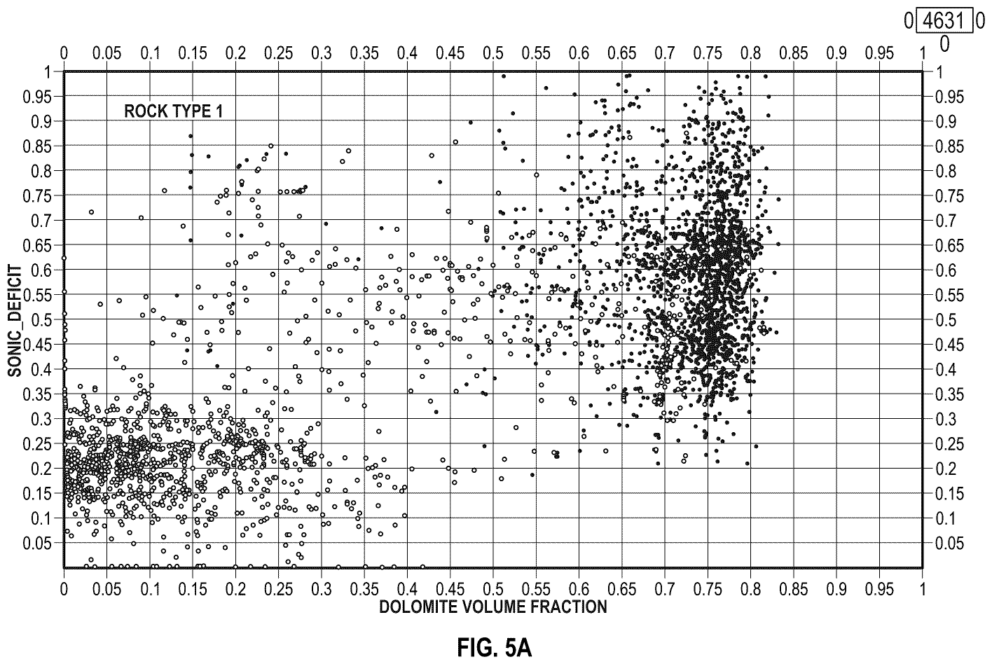

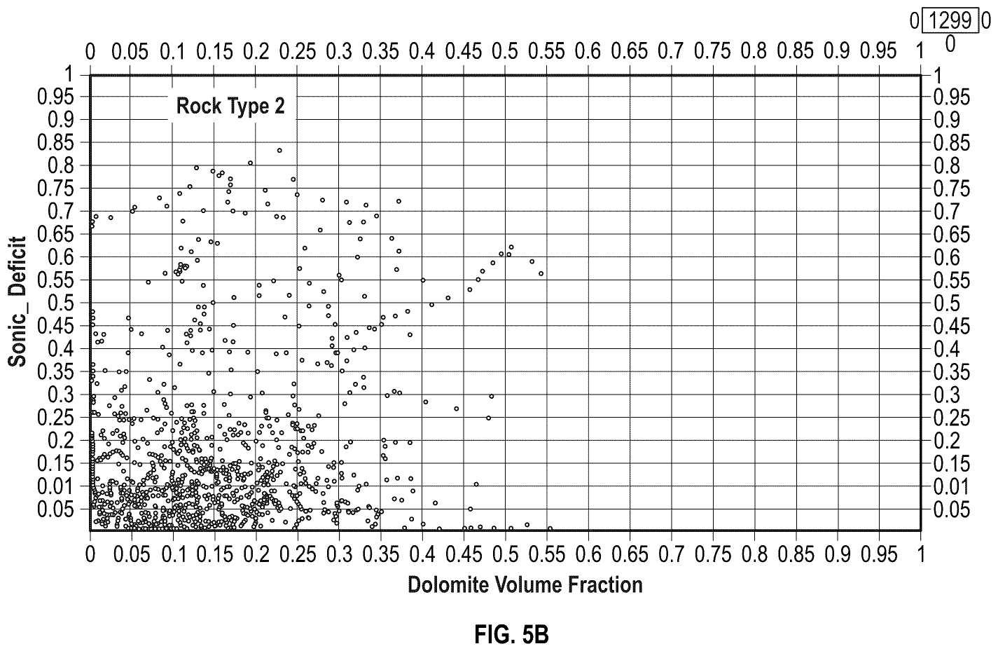

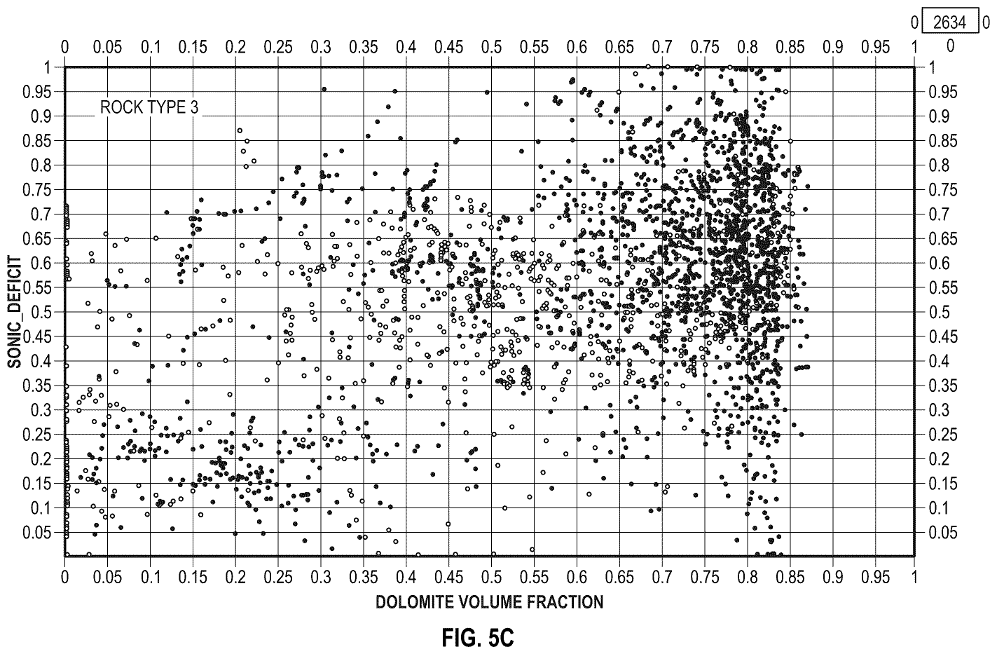

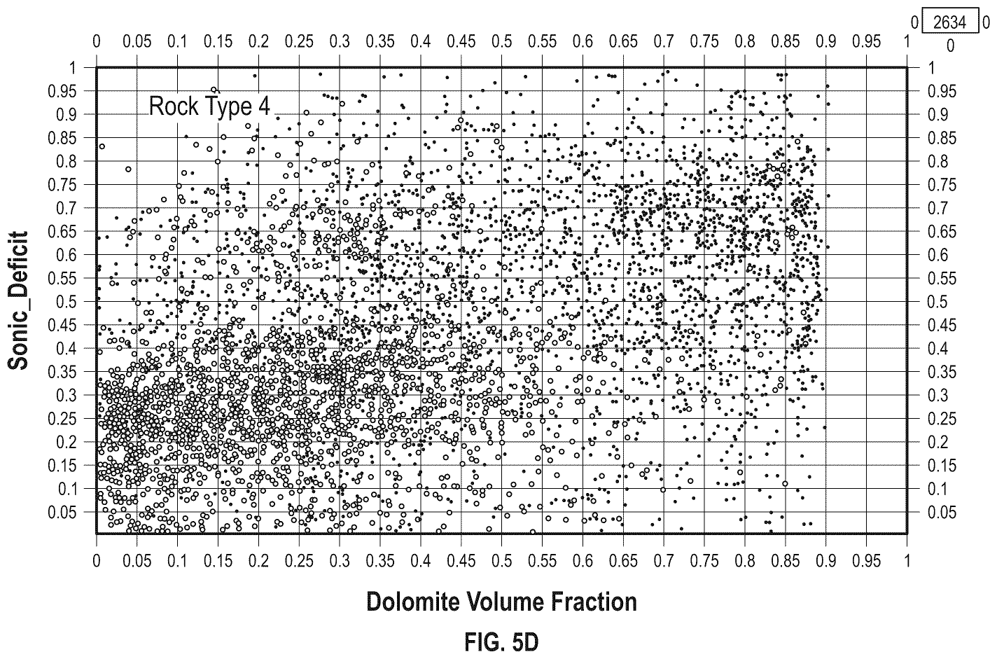

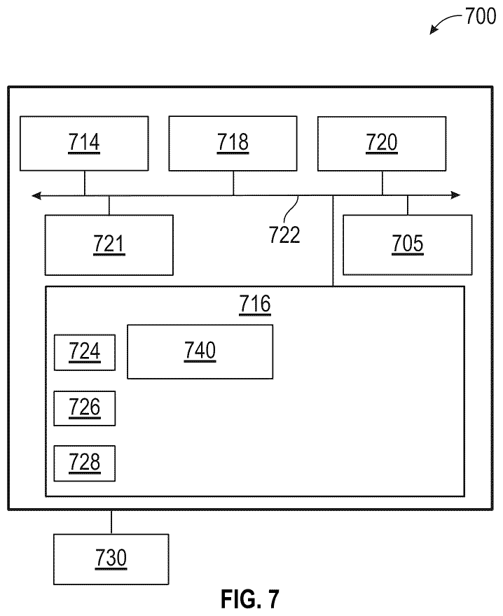

FIGS. 5A-D depict graphs of SWP deficits (“sonic deficit”) vs dolomite volume fractions, as depicted in FIG. 3, separated by NMR rock type, as depicted in FIG. 1, according to one or more embodiments. FIG. 5A depicts NMR rock type 1 710, FIG. 5B depicts NMR rock type 2 720, FIG. 5C depicts NMR rock type 3 730, and FIG. 5D depicts NMR rock type 4 740. As depicted in FIGS. 5A and 7C, porous dolomite can correlate to RT-1 and RT-3 rock types, indicating that, regardless of their porosity, dolomite can be located by long T₁ and/or T₂ components, corresponding to the largest pore sizes, with the majority of concentrated dolomite being RT-1 rock type. The dolomite rocks also have a larger sonic deficit, indicating that, in addition to the larger pore size, the pores are also more spherical, which indicates that the diagenetic effect of dolomitization enhances the rock quality.

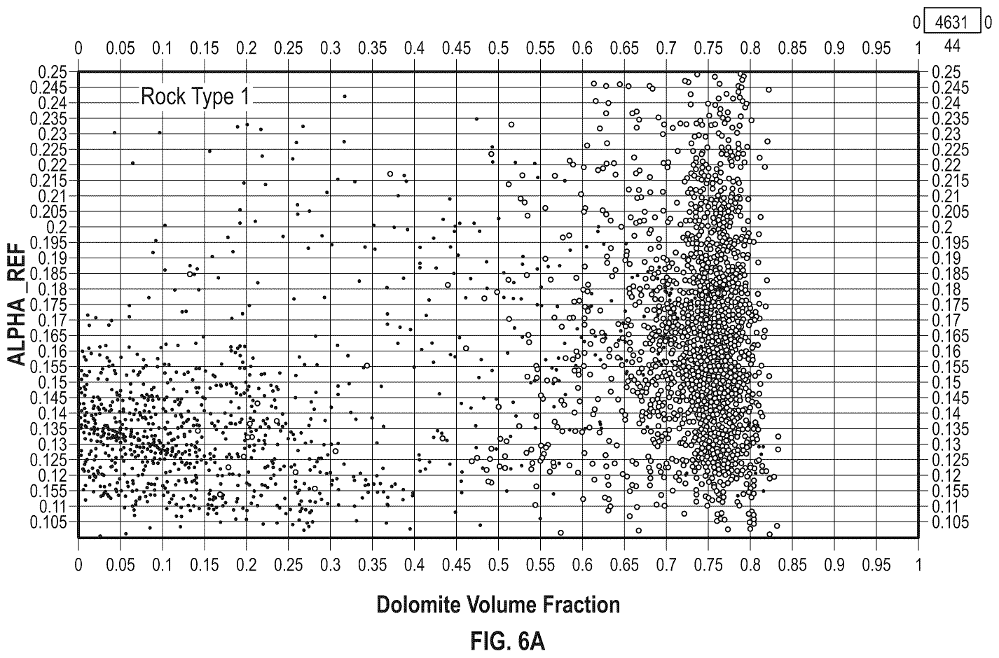

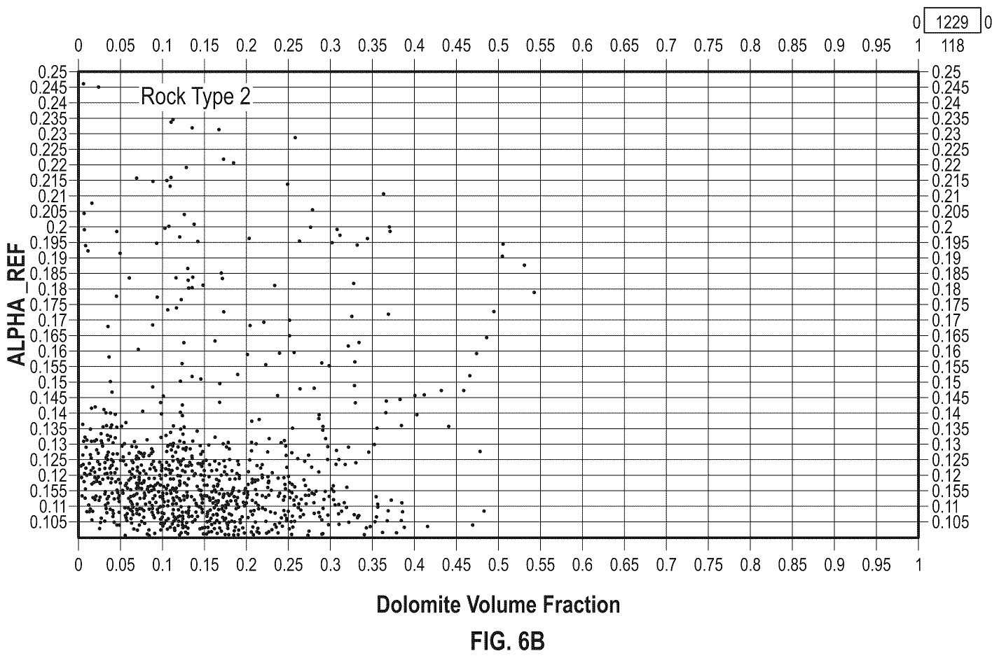

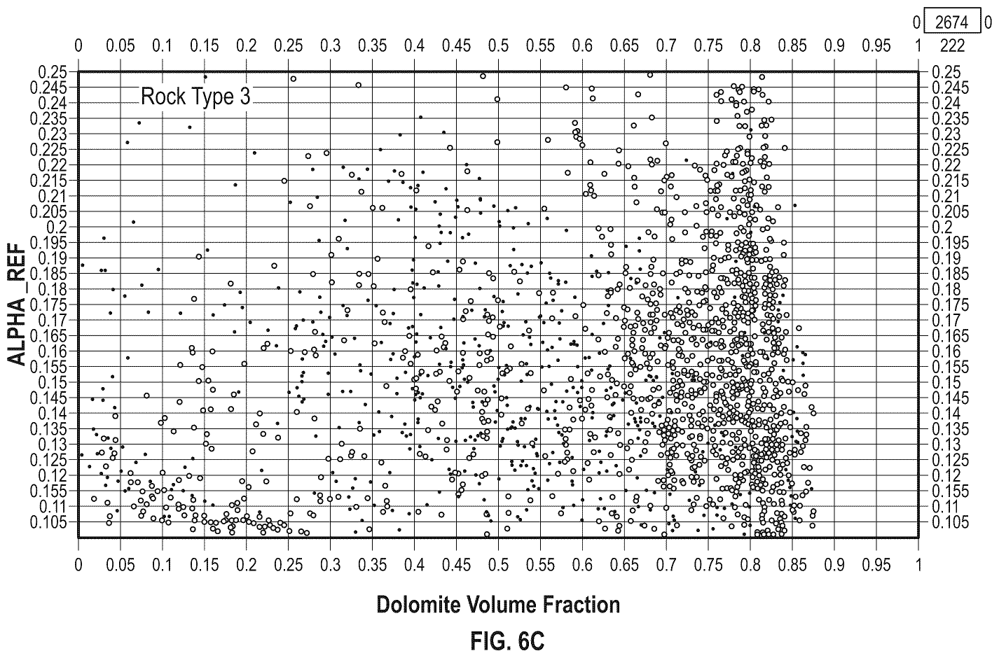

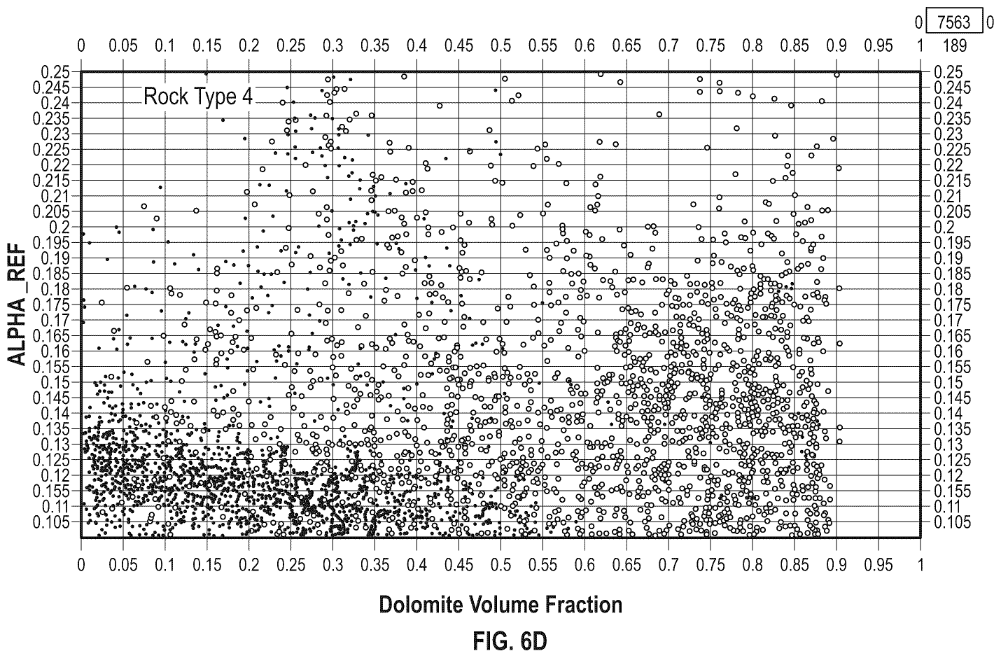

FIGS. 6A-D depict graphs of average acoustic pore aspect ratios (“ALPHA REF”) vs dolomite volume fractions, as depicted in FIG. 3, separated by NMR rock type, as depicted in FIG. 1, according to one or more embodiments. FIG. 6A depicts NMR rock type 1 810, FIG. 6B depicts NMR rock type 2 820, FIG. 6C depicts NMR rock type 3 830, and FIG. 6D depicts NMR rock type 4 840. As depicted in FIGS. 6A and 8C, porous dolomite can correlate to RT-1 and RT-3 rock types, indicating that regardless of their porosity, dolomite can be located by long T₁ and/or T₂ components, corresponding to the largest pore sizes, with the majority of concentrated dolomite being RT-1 rock type. The dolomite rocks also have a larger average aspect ratio, indicating that, in addition to the larger pore size, the pores are also more spherical, which indicates that the diagenetic effect of dolomitization enhances the rock quality.

In one or more embodiments, one or more preferred formation locations can be determined from the acquisition of NMR rock types, NMR BFV, average acoustic pore aspect ratios, SWP deficits, dolomite volume fractions, and combinations and/or correlations of the same. In one or more embodiments, one or more preferred formation locations can be determined from the comparison of the dolomite volume fraction and the NMR BFV. The comparison of the dolomite volume fraction and the NMR BFV can identify locations within the formation that simultaneously contain higher dolomitization and lower bound fluid volume, compared to the surrounding reservoir rock. In one or more embodiments, one or more preferred formation locations can be determined by characterizing a plurality of formation locations based on a plurality of rock types. The plurality of rock types can include two or more of the following: RT-1, RT-2, RT-3, and/or RT-4. In some embodiments, the one or more preferred formation locations can be selected from areas that include RT-1 rock types. In one or more embodiments, one or more preferred formation locations can be based on a level of dolomitization, a characterized rock quality, or a combination thereof. The level of dolomitization can include dolomite volume fraction. The characterized rock quality can be any one of the following: RT-1, RT-2, RT-3, and/or RT-4. In some embodiments, preferred formation locations include enhanced rock quality locations. Enhanced rock quality locations can include high porosity, large pore size, and high average acoustic pore aspect ratios that indicate more spherical pore shapes.

One or more preferred formation locations can include any formation location that allows for an operational plan, according to user desires and/or preferences. The operational plan can include one or more field operations, well operations, reservoir operations, and the like. In one or more embodiments, the operational plan can include directing drilling or hydrocarbon production operations. In one or more embodiments, the operational plan can include directing drilling or hydrocarbon production operations to occur at or near the one or more preferred formation locations.

In one or more embodiments, the one or more preferred formation locations can be determined manually or automatically. Automatic determination of the one or more preferred formation locations can include algorithms, machine learning, neural networks, and/or any suitable automated process for acquiring, calculating, computing, combining, correlating, and the like, data such as NMR rock types, average acoustic pore aspect ratios, SWP deficits, and dolomite volume fractions. In some embodiments, a neural network can be used to automatically determine one or more preferred formation locations.

FIG. 7 depicts a schematic of an illustrative computing system 700 that can be configured to determine one or more preferred formation locations, according to one or more embodiments. The computer system 700 can be located within a facility or can be located elsewhere. One or more chips, for example chips 705 and/or 721, can be or can include field-programmable gate arrays (“FPGAs”), application specific integrated circuits (“ASICs”), chiplets, Multi-Chip-Modules, central processing units (“CPUs”), and/or system-on-chips (“SOCs”), to name a few. The chip can be used in a wide-range of applications, including but not limited to image processing, input data organization, or other digital processing systems. The ASICs can include entire microprocessors, memory blocks including read only memory (ROM), random access memory (RAM), erasable programmable read only memory (EPROM), electrically erasable programmable read only memory (EEPROM), flash memory and other building blocks and can be known as system-on-chip (“SoC”).

To achieve its desired functionality, the computing system 700 can include various hardware and software components. Among these components can be one or more processors 714 and a command actuator 740. These hardware components can be interconnected through the use of a number of electrical connections, buses, and/or network connections. In one embodiment, the processor 714, the chip 705, the chip 721, and the command actuator 740 can be communicatively coupled via a bus 722. The bus 722 can be or include any know computing system bus. The command actuator 740 can be internal to a data storage device 716.

The chip 705, the chip 721, and/or the command actuator 740 can include, either separately or in some combination, software and hardware, including tangible, non-transitory computer readable medium (not shown), for determining one or more preferred formation locations. In some embodiments, the determining one or more preferred formation locations can be interpreted via statistical formulas, such as average mean, median, standard deviation, and the like, or any combination thereof, and/or complex formulas, such as factor analysis, Fourier's transform, logarithmic methods, and the like, or any combination thereof. Other known algorithms and/or suitable algorithms developed in the future can also be used. In some embodiments, the command actuator 740 can be integrated into the chip 705, the chip 721, and/or the processor 714. In some embodiments, the chip 705 and/or the chip 721 can be integrated into the processor 714. Although the command actuator 740 is depicted as being internal to the data storage device 716, in other embodiments, the command actuator 740 can be a peripheral device (not shown) coupled to the computing system 712 or included within a peripheral device (not shown) coupled to the computing system 712.

The command actuator 740 can include instructions that when executed by the command actuator 740 can cause the command actuator 740 to implement at least the functionality of receiving information through a network adapter, processing the information from two or more downhole logs through the processor according to the instructions stored in the memory to create a command, and for determining one or more preferred formation locations according to the command. In some embodiments, the instructions can, when executed by the command actuator 740, cause the command actuator 740 to use one or more inversion procedures or techniques to determine one or more preferred formation locations using the information received. In some embodiments, the instructions can, when executed by the command actuator 740, cause the command actuator 740 to use one or more analyses to determine one or more preferred formation locations using the one or more models.

In one or more embodiments, the command actuator 740 can work in conjunction with the processor 714 to implement the functionality described above. In some embodiments, the command actuator 740 can execute firmware code stored on the computing system 700, such as on the chip 705, the chip 721, and/or the processor 714. The functionality of the computing system 700 and/or the command actuator 740 can be in accordance with the processes of the present specification described herein. In the course of executing code, the processor 714 and/or the command actuator 740 can receive input from and provide output to a number of the remaining hardware units.

The computing system 700 can be implemented in an electronic device. Examples of electronic devices include servers, desktop computers, laptop computers, cloud-based computers, personal digital assistants (“PDAs”), mobile devices, smartphones, gaming systems, and tablets, among other electronic devices. The computing system 700 can be utilized in any data processing scenario including, stand-alone hardware, mobile applications, through a computing network, or combinations thereof. Further, the computing system 700 can be used in a computing network, a public cloud network, a private cloud network, a hybrid cloud network, other forms of networks, or combinations thereof. In one example, the processes provided by the computing system 700 can be provided as a service by a third party.

To achieve its desired functionality, the computing system 700 can include various other hardware components. Among these other hardware components can be a number of data storage devices or tangible, non-transitory computer readable medium 716, a number of peripheral device adapters 718, and a number of network adapters 720. These hardware components can be interconnected through the use of a number of electrical connections, busses, and/or network connections.

The chip 705, the chip 721, and/or the processor 714 can include the hardware and/or firmware/software architecture to retrieve executable code from the data storage device 716 and execute the executable code. The executable code can, when executed by the chip 705, the chip 721, and/or the processor 714, cause the chip 705, the chip 721, and/or the processor 714 to implement at least the functionality of receiving information through a network adapter, processing the information from the two or more downhole logs and determining one or more preferred formation locations according to the command.

The data storage device 716 can store data such as executable program code that is executed by the processor 714, the command actuator 740, or other processing devices. The processor 714 can be a central processing unit that is to execute an operating system in the computing system 700. As will be discussed, the data storage device 716 can specifically store computer code representing a number of applications that the processor 714 and/or the command actuator 740 can execute to implement at least the functionality described herein.

In one or more embodiments, the data storage device 716 can include various types of memory modules, including volatile and nonvolatile memory. In one or more embodiments, the data storage device 716 of the present example can include Random Access Memory (“RAM”) 724, Read Only Memory (“ROM”) 726, and Hard Disk Drive (“HDD”) storage 728. Many other types of memory can also be utilized, and the present specification contemplates the use of many varying type(s) of memory in the data storage device 716 as can suit a particular application of the principles described herein. In certain examples, different types of memory in the data storage device 716 can be used for different data storage requirements. In one or more embodiments, in certain examples the processor 714 can boot from Read Only Memory (“ROM”) 726, maintain nonvolatile storage in the Hard Disk Drive (“HDD”) memory 728, and execute program code stored in Random Access Memory (“RAM”) 724. In examples, the chip 705, and the chip 721 can boot from the Read Only Memory (“ROM”) 726.

The data storage device 716 can include a computer readable medium, a computer readable storage medium, or a non-transitory computer readable medium, among others. In one or more embodiments, the data storage device 716 can be an electronic, magnetic, optical, electromagnetic, infrared, or semiconductor system, apparatus, or device, or any suitable combination of the foregoing. More specific examples of the computer readable storage medium can include, for example, the following: an electrical connection having a number of wires, a portable computer diskette, a hard disk, a RAM, a ROM, an EPROM, a Flash memory, a portable compact disc read only memory (“CD-ROM”), an optical storage device, a magnetic storage device, or any suitable combination of the foregoing. In the context of this document, a computer readable storage medium can be any tangible medium that can contain, or store computer usable program code for use by or in connection with an instruction execution system, apparatus, or device. In another example, a computer readable storage medium can be any non-transitory medium that can contain or store a program for use by or in connection with an instruction execution system, apparatus, or device.

The hardware adapters 718, 720 in the computing system 700 can enable the processor 714 to interface with various other hardware components, external and internal to the computing system 700. In one or more embodiments, the peripheral device adapters 718 can provide an interface to input/output devices, such as, for example, a display device 730, a mouse, and/or a keyboard. The peripheral device adapters 718 can also provide access to other external devices such as an external storage device, a number of network devices such as, for example, servers, switches, and routers, client devices, other types of computing devices, and combinations thereof.

The display device 730 can be provided to allow a user of the computing system 700 to interact with and implement the functionality of the computing system 700. Examples of display devices 730 can include a computer screen, a laptop screen, a mobile device screen, a personal digital assistant (“PDA”) screen, and/or a tablet screen, among other display devices 730.

The peripheral device adapters 718 can also create an interface between the processor 714 and the display device 730, a printer, or other media output devices. The network adapter 720 can provide an interface to other computing devices within, for example, a network, thereby enabling the transmission of data between the computing system 700 and other devices located within the network. The network adapter 720 can provide an interface to an external telecommunications network such as a cellular phone network or other radio frequency enabled network, thereby enabling the transmission of data between the computing system 700 and other external devices such as an external storage device, a number of network devices such as, for example, servers, switches, and routers, client servers, radio frequency enabled devices, other client devices, other types of computing devices, and combinations thereof.

The computing system 700 can further include a number of modules used in the implementation of the process and systems described herein. The various modules within the computing system 700 can include executable program code that can be executed separately. In this example, the various modules can be stored as separate computer program products. In another example, the various modules within the computing system 700 can be combined within a number of computer program products; each computer program product including a number of the modules.

The present disclosure further relates to any one or more of the following numbered embodiments:

A1. A process, comprising: determining an average acoustic pore aspect ratio of a formation from an acoustic log of the formation; determining one or more nuclear magnetic resonance (NMR) rock types of the formation from an NMR log of the formation; combining the average acoustic pore aspect ratio and the one or more NMR rock types to determine one or more preferred formation locations; and directing an operational plan for one or more wells using the one or more preferred formation locations.

A2. The process of paragraph A1, further comprising calculating an initial estimation using the Wyllie equation,

$$\frac{1}{v} = \frac{{Φ}_{t}}{{v}_{f}} + \frac{1 - {Φ}_{t}}{{v}_{m}} ,$$

wherein v is phase velocity, v_{f} is fluid velocity, vₘ is rock matrix velocity, and Φₜ is total porosity.

A3. The process of claim A2, wherein the initial estimation using the Wyllie equation is compared to a total porosity from a standard formation evaluation process, wherein the total porosity is given by the equation,

$${Φ}_{t} = \frac{{R}_{ma} - {R}_{B}}{{R}_{ma} - ( {R}_{mf} \cdot {S}_{xo} + {R}_{HC} \cdot ( 1 - {S}_{xo} ) )} ,$$

and wherein Rₘₐ is grain density, R_{B} is density log measurement, R_{mf} is mud filtrate density, R_{HC} is hydrocarbon density and Sₓₒ is water saturation.

A4. The process of any one of paragraphs A1 to A3, wherein the one or more NMR rock types is derived from NMR T₁ distribution log means or NMR T₂ distribution log means and NMR porosity.

A5. The process of any one of paragraphs A1 to A4, wherein the one or more NMR rock types is derived from NMR T₁ distribution log means and NMR T₂ distribution log means and NMR porosity.

A6. The process of any one of paragraphs A1 to A5, wherein determining the one or more preferred formation locations comprises comparing a dolomite volume fraction and an NMR bound fluid volume.

A7. The process of any one of paragraphs A1 to A6, wherein determining the one or more preferred formation locations comprises characterizing a plurality of formation locations based on a plurality of rock types.

A8. The process of any one of paragraphs A1 to A7, wherein determining the one or more preferred formation locations is based on a level of dolomitization, a characterized rock quality, or a combination thereof.

A9. The process of any one of paragraphs A1 to A8, wherein directing the operational plan includes directing drilling or hydrocarbon production operations to occur at or near the one or more preferred formation locations.

A10. The process of any one of paragraphs A1 to A9, further comprising neural networks, machine learning, and/or an automated process to determine the one or more preferred formation locations.

B1. A process, comprising: locating one or more logging tools in a wellbore traversing a formation to obtain acoustic and nuclear magnetic resonance (NMR) logs of the formation; determining an average acoustic pore aspect ratio of the formation from the acoustic log of the formation; determining one or more NMR rock types of the formation from the NMR log of the formation; combining the average acoustic pore aspect ratio and the one or more NMR rock types to determine one or more preferred formation locations; and directing an operational plan for one or more wells using the one or more preferred formation locations.

B2. The process of paragraph B1, further comprising calculating an initial estimation using the Wyllie equation,

$$\frac{1}{v} = \frac{{Φ}_{t}}{{v}_{f}} + \frac{1 - {Φ}_{t}}{{v}_{m}} ,$$

wherein v is phase velocity, v_{f} is fluid velocity, vₘ is rock matrix velocity, and Pt is total porosity.

B3. The process of claim B2, wherein the initial estimation using the Wyllie equation is compared to a total porosity from a standard formation evaluation process, wherein the total porosity is given by the equation,

$${Φ}_{t} = \frac{{R}_{ma} - {R}_{B}}{{R}_{ma} - ( {R}_{mf} \cdot {S}_{xo} + {R}_{HC} \cdot ( 1 - {S}_{xo} ) )} ,$$

and wherein Rₘₐ is grain density, R_{B} is density log measurement, R_{mf} is mud filtrate density, RAC is hydrocarbon density and Sₓₒ is water saturation.

B4. The process of any one of paragraphs B1 to B3, wherein the one or more NMR rock types is derived from NMR T₁ distribution log means or NMR T₂ distribution log means and NMR porosity.

B5. The process of any one of paragraphs B1 to B4, wherein the one or more NMR rock types is derived from NMR T₁ distribution log means and NMR T₂ distribution log means and NMR porosity.

B6. The process of any one of paragraphs B1 to B5, wherein determining the one or more preferred formation locations comprises comparing a dolomite volume fraction and an NMR bound fluid volume.

B7. The process of any one of paragraphs B1 to B6, wherein determining the one or more preferred formation locations comprises characterizing a plurality of formation locations based on a plurality of rock types.

B8. The process of any one of paragraphs B1 to B7, wherein determining the one or more preferred formation locations is based on a level of dolomitization, a characterized rock quality, or a combination thereof.

B9. The process of any one of paragraphs B1 to B8, wherein directing the operational plan includes directing drilling or hydrocarbon production operations to occur at or near the one or more preferred formation locations.

B10. The process of any one of paragraphs B1 to B9, further comprising neural networks, machine learning, and/or an automated process to determine the one or more preferred formation locations.

While the present disclosure may be susceptible to various modifications and alternative forms, specific embodiments have been shown by way of example in the drawings and have been described in detail herein. However, it should be understood that the present disclosure is not intended to be limited to the particular forms disclosed. Rather, the present disclosure is intended to cover all modifications, equivalents, and alternatives falling within the spirit and scope of the present disclosure as defined by the following appended claims.

Certain embodiments and features have been described using a set of numerical upper limits and a set of numerical lower limits. It should be appreciated that ranges including the combination of any two values, e.g., the combination of any lower value with any upper value, the combination of any two lower values, and/or the combination of any two upper values are contemplated unless otherwise indicated. Certain lower limits, upper limits and ranges appear in one or more paragraphs Below. All numerical values are “about” or “approximately” the indicated value, and take into account experimental error and variations that would be expected by a person having ordinary skill in the art.

Various terms have been defined above. To the extent a term used in a claim can be not defined above, it should be given the broadest definition persons in the pertinent art have given that term as reflected in at least one printed publication or issued patent. Furthermore, all patents, test procedures, and other documents cited in this application are fully incorporated by reference to the extent such disclosure can be not inconsistent with this application and for all jurisdictions in which such incorporation can be permitted.

While certain preferred embodiments of the present invention have been illustrated and described in detail above, it can be apparent that modifications and adaptations thereof will occur to those having ordinary skill in the art. It should be, therefore, expressly understood that such modifications and adaptations may be devised without departing from the basic scope thereof, and the scope thereof can be determined by the claims that follow.

What is claimed is:

1. A process, comprising:
determining an average acoustic pore aspect ratio of a formation from an acoustic log of the formation;
determining one or more nuclear magnetic resonance (NMR) rock types of the formation from an NMR log of the formation;
combining the average acoustic pore aspect ratio and the one or more NMR rock types to determine one or more preferred formation locations; and
directing an operational plan for one or more wells using the one or more preferred formation locations.

2. The process of claim 1, further comprising calculating an initial estimation using the Wyllie equation,
$$\frac{1}{v} = \frac{{Φ}_{t}}{{v}_{f}} + \frac{1 - {Φ}_{t}}{{v}_{m}} ,$$
wherein v is phase velocity, v_{f} is fluid velocity, vₘ is rock matrix velocity, and Φₜ is total porosity.

3. The process of claim 2, wherein the initial estimation using the Wyllie equation is compared to a total porosity from a standard formation evaluation process, wherein the total porosity is given by the equation,
$${Φ}_{t} = \frac{{R}_{ma} - {R}_{B}}{{R}_{ma} - ( {R}_{mf} \cdot {S}_{xo} + {R}_{HC} \cdot ( 1 - {S}_{xo} ) )} ,$$
and wherein Rₘₐ is grain density, R_{B} is density log measurement, R_{mf} is mud filtrate density, R_{HC} is hydrocarbon density and Sₓₒ is water saturation.

4. The process of claim 1, wherein the one or more NMR rock types is derived from NMR T₁ distribution log means or NMR T₂ distribution log means and NMR porosity.

5. The process of claim 1, wherein the one or more NMR rock types is derived from NMR T₁ distribution log means and NMR T₂ distribution log means and NMR porosity.

6. The process of claim 1, wherein determining the one or more preferred formation locations comprises comparing a dolomite volume fraction and an NMR bound fluid volume.

7. The process of claim 1, wherein determining the one or more preferred formation locations comprises characterizing a plurality of formation locations based on a plurality of rock types.

8. The process of claim 1, wherein determining the one or more preferred formation locations is based on a level of dolomitization, a characterized rock quality, or a combination thereof.

9. The process of claim 1, wherein directing the operational plan includes directing drilling or hydrocarbon production operations to occur at or near the one or more preferred formation locations.

10. The process of claim 1, further comprising neural networks, machine learning, and/or an automated process to determine the one or more preferred formation locations.

11. A process, comprising:
locating one or more logging tools in a wellbore traversing a formation to obtain acoustic and nuclear magnetic resonance (NMR) logs of the formation;
determining an average acoustic pore aspect ratio of the formation from the acoustic log of the formation;
determining one or more NMR rock types of the formation from the NMR log of the formation;
combining the average acoustic pore aspect ratio and the one or more NMR rock types to determine one or more preferred formation locations; and
directing an operational plan for one or more wells using the one or more preferred formation locations.

12. The process of claim 11, further comprising calculating an initial estimation using the Wyllie equation,
$$\frac{1}{v} = \frac{{Φ}_{t}}{{v}_{f}} + \frac{1 - {Φ}_{t}}{{v}_{m}} ,$$
wherein v is phase velocity, v_{f} is fluid velocity, vₘ is rock matrix velocity, and Φₜ is total porosity.

13. The process of claim 12, wherein the initial estimation using the Wyllie equation is compared to a total porosity from a standard formation evaluation process, wherein the total porosity is given by the equation,
$${Φ}_{t} = \frac{{R}_{ma} - {R}_{B}}{{R}_{ma} - ( {R}_{mf} \cdot {S}_{xo} + {R}_{HC} \cdot ( 1 - {S}_{xo} ) )} ,$$
and wherein Rₘₐ is grain density, R_{B} is density log measurement, R_{mf} is mud filtrate density, R_{HC} is hydrocarbon density and Sₓₒ is water saturation.

14. The process of claim 11, wherein the one or more NMR rock types is derived from NMR T₁ distribution log means or NMR T₂ distribution log means and NMR porosity.

15. The process of claim 11, wherein the one or more NMR rock types is derived from NMR T₁ distribution log means and NMR T₂ distribution log means and NMR porosity.

16. The process of claim 11, wherein determining the one or more preferred formation locations comprises comparing a dolomite volume fraction and an NMR bound fluid volume.

17. The process of claim 11, wherein determining the one or more preferred formation locations comprises characterizing a plurality of formation locations based on a plurality of rock types.

18. The process of claim 11, wherein determining the one or more preferred formation locations is based on a level of dolomitization, a characterized rock quality, or a combination thereof.

19. The process of claim 11, wherein directing the operational plan includes directing drilling or hydrocarbon production operations to occur at or near the one or more preferred formation locations.

20. The process of claim 11, further comprising neural networks, machine learning, and/or an automated process to determine the one or more preferred formation locations.
